(19) United States
(12) Patent Application Publication
(10) Pub. No.: US 2025/0377621 A1
(43) Pub. Date: Dec. 11, 2025

(54) IMAGE FORMING APPARATUS AND IMAGE FORMING METHOD

(71) Applicant: SHARP KABUSHIKI KAISHA, Sakai City (JP)

(72) Inventor: MASAYA FUJITANI, Sakai City (JP)

(21) Appl. No.: 19/223,352

(22) Filed: May 30, 2025

(30) Foreign Application Priority Data
Jun. 6, 2024 (JP) 2024-091873

(51) Int. Cl. G03G 15/00; H04N 1/407; H04N 1/60

(52) U.S. Cl. CPC G03G 15/5062; H04N 1/4078; H04N 1/6033; G03G 2215/00067

(57) ABSTRACT

A controller generates first supplement density data from certain parts of a plurality of density input values and a plurality of pieces of first detection density data by at least one of interpolation and extrapolation of a plurality of pieces of first detection density data, generates second supplement density data from other parts of a plurality of density input values and a plurality of pieces of second detection density data by at least one of interpolation and extrapolation of a plurality of pieces of second detection density data, and generates gradation correction data using the plurality of pieces of first detection density data, the plurality of pieces of second detection density data, the first supplement density data, and the second supplement density data.

### CROSS-REFERENCE TO RELATED APPLICATIONS

The present application claims priority from Japanese Application JP2024-091873 filed on Jun. 6, 2024, the content to which is hereby incorporated by reference into this application.

### BACKGROUND

### Field

The present disclosure relates to an image forming apparatus and an image forming method.

### Related Art

In recent years, in an image forming apparatus, a test pattern image including a patch image group has been developed. The image forming apparatus uses the test pattern image to perform calibration of the print density of colors of an image formed on a recording material.

### SUMMARY

The image forming apparatus forms a single set of patch images corresponding to all density input values on each of the front side and the rear side of a recording material.

The use of a smaller number of patch images leads to a reduction in the accuracy of calibration.

The present disclosure has been made in view of the above problem. An object of the present disclosure is to provide an image forming apparatus and an image forming method capable of achieving a test pattern image including a smaller number of patch images without reducing the accuracy of calibration.

An image forming apparatus of the present disclosure comprises: an image reader that reads a test pattern image; an image former that forms an image on a recording material; and a controller that controls the image reader and the image former, wherein the controller causes the test pattern image to be formed on the recording material, the test pattern image including a plurality of first patch images that correspond to certain parts of a plurality of density input values and a plurality of second patch images that correspond to other parts of the plurality of density input values, acquires a plurality of pieces of first detection density data that correspond to the plurality of first patch images and a plurality of pieces of second detection density data that correspond to the plurality of second patch images, in a case where the test pattern image is read by the image reader, generates first supplement density data from the certain parts of the plurality of density input values and the plurality of pieces of first detection density data by at least one of interpolation and extrapolation of the plurality of pieces of first detection density data, generates second supplement density data from the other parts of the plurality of density input values and the plurality of pieces of second detection density data by at least one of interpolation and extrapolation of the plurality of pieces of second detection density data, generates gradation correction data using the plurality of pieces of first detection density data, the plurality of pieces of second detection density data, the first supplement density data, and the second supplement density data, and the image former forms the image on the recording material based on the gradation correction data.

An image forming method executed by one or more processors of the present disclosure, comprises: forming, on a recording material, a test pattern image including a plurality of first patch images that correspond to certain parts of a plurality of density input values and a plurality of second patch images that correspond to other parts of the plurality of density input values, acquiring a plurality of pieces of first detection density data that correspond to the plurality of first patch images and a plurality of pieces of second detection density data that correspond to the plurality of second patch images, in a case where the test pattern image is read from the recording material, generating first supplement density data from the certain parts of the plurality of density input values and the plurality of pieces of first detection density data by at least one of interpolation and extrapolation of the plurality of pieces of first detection density data, generating second supplement density data from the other parts of the plurality of density input values and the plurality of pieces of second detection density data by at least one of interpolation and extrapolation of the plurality of pieces of second detection density data, generating gradation correction data using the plurality of pieces of first detection density data, the plurality of pieces of second detection density data, the first supplement density data, and the second supplement density data, and forming the image on the recording material based on the gradation correction data.

### BRIEF DESCRIPTION OF THE DRAWINGS

FIG. 1 is a structure diagram of an image forming apparatus according to a first embodiment.

FIG. 2 is a functional block diagram of the image forming apparatus according to the first embodiment.

FIG. 3 is a flowchart illustrating a process performed by a controller of the image forming apparatus according to the first embodiment.

FIG. 4 is a diagram illustrating a test pattern image of an image forming apparatus according to a comparative example.

FIG. 5 is a diagram illustrating a test pattern image of the image forming apparatus according to the first embodiment.

FIG. 6 is a diagram illustrating a relationship between a density input value and an average value of two detection density data on the front side and the rear side of the image forming apparatus according to the comparative example.

FIG. 7 is a diagram illustrating a relationship between a density input value, two detection density data (detection results) and two supplement density data (estimation results) on the front side and the rear side, and an average value of the two detection density data and the two supplement density data of the image forming apparatus according to the first embodiment.

FIG. 8 is a graph illustrating a relationship between a density input value and an average value of two detection density data on the front side and the rear side of the image forming apparatus according to the comparative example.

FIG. 9 is a graph illustrating a relationship between a density input value and an average value of two detection density data on the front side and the rear side of the image forming apparatus according to the first embodiment.

FIG. 10 is a diagram illustrating a test pattern image of an image forming apparatus according to a second embodiment.

FIG. 11 is a diagram illustrating a relationship between the magnitude of temperature and humidity and an additional value of an image forming apparatus according to a third embodiment.

FIG. 12 is a diagram illustrating a relationship between the freshness of a developer and an additional value of the image forming apparatus according to the third embodiment.

FIG. 13 is a diagram illustrating a relationship between the freshness of a photoreceptor and an additional value of the image forming apparatus according to the third embodiment.

FIG. 14 is a diagram illustrating a relationship between the length of time for which the image forming apparatus is left and an additional value of the image forming apparatus according to the third embodiment.

FIG. 15 is a diagram illustrating an example of the number of patch images that is determined based on a density input value and additional values of the image forming apparatus according to the third embodiment.

FIG. 16 is a diagram illustrating a test pattern image of the image forming apparatus according to the third embodiment.

FIG. 17 is a diagram illustrating a relationship between a density input value, detection density data (detection results) and supplement density data (estimation results) on the front side and the rear side, and an average value of the detection density data and the supplement density data of the image forming apparatus according to the third embodiment.

### DETAILED DESCRIPTION

An image forming apparatus according to embodiments of the present disclosure will be described below with reference to the drawings. In the drawings, the same or equivalent elements are denoted by the same reference numerals, and redundant description will not be repeated.

### First Embodiment

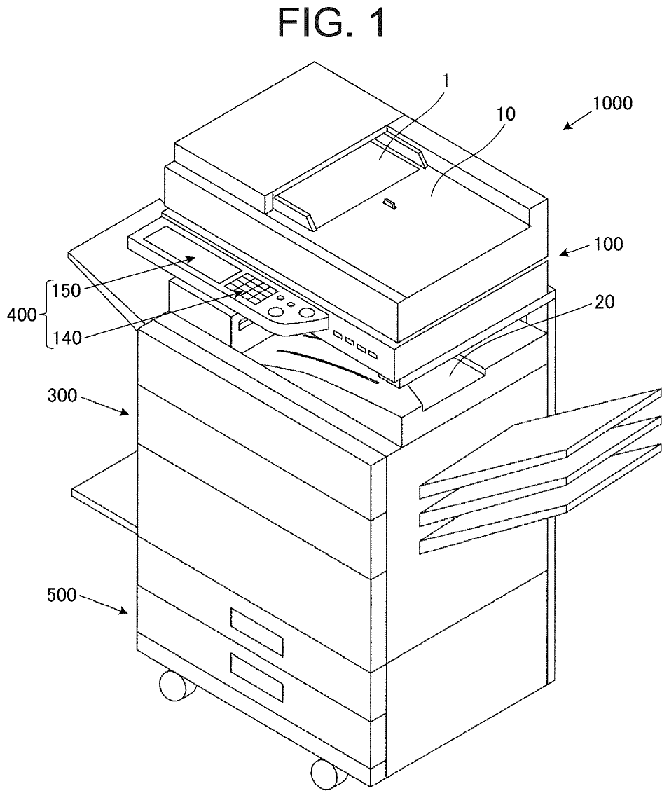

An image forming apparatus 1000 and an image forming method according to a first embodiment will be described with reference to FIGS. 1 to 9.

### Overall Configuration of Image Forming Apparatus 1000

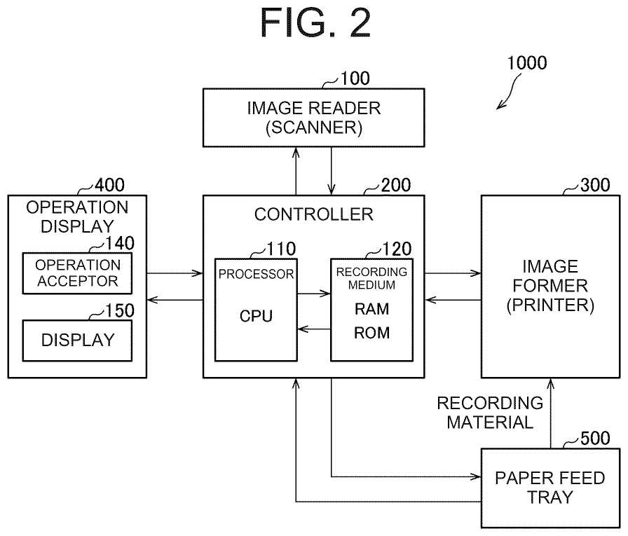

FIGS. 1 and 2 are, respectively, a structure diagram and a functional block diagram of the image forming apparatus 1000 according to the present embodiment.

As illustrated in FIGS. 1 and 2, the image forming apparatus 1000 includes an image r reader 100, a controller 200, an image former 300, an operation display 400, and a paper feed tray 500. The operation display 400 includes a push-button switch 140 (or an operation acceptor 140) that is turned on by a pressing operation, and a display 150 that displays a switch icon that is turned on by a touch operation.

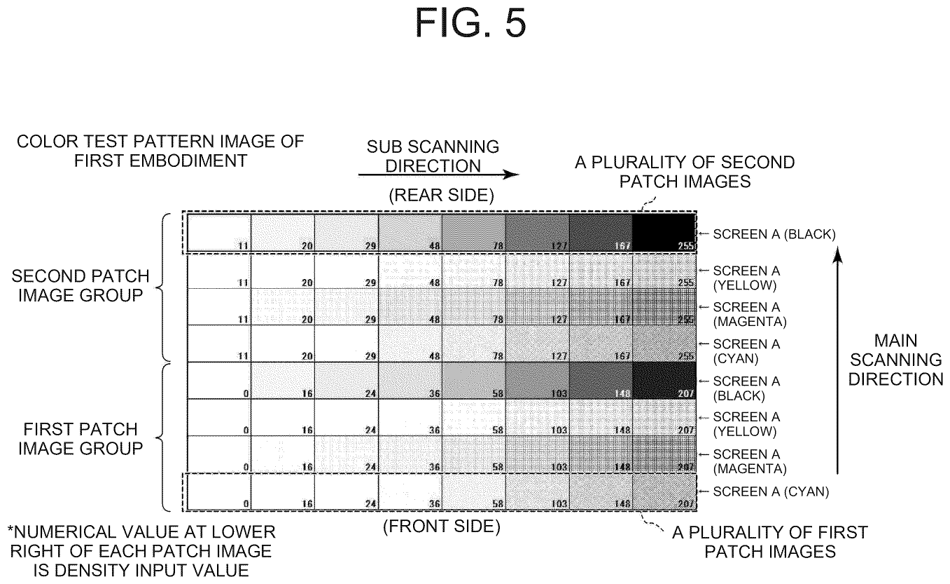

The image reader 100 is a device called a scanner. Specifically, the image reader 100 reads an image including a character, a picture, or the like on a recording material 1, for example, a sheet of paper, placed on a manual feed tray 10, and generates electronic data of the image. That is, the image reader 100 generates, from a document (recording material 1) including an original image, image data corresponding to the original image. The image reader 100 may be a scanner dedicated to a test pattern image (see FIG. 5) that is used only to form a test pattern image on the recording material 1.

The controller 200 controls the entire image forming apparatus 1000. For example, the controller 200 controls the image reader 100 and the image former 300. The controller 200 is referred to as a controller. The controller 200 includes a memory as a recording medium 120 in which a program for image formation is recorded. The memory includes a read-only memory (ROM) as a fixed recording medium, and a random-access memory (RAM) as a temporary recording medium. Furthermore, the controller 200 includes a central processing unit (CPU) as a processor 110 that performs a process for operating the image reader 100 and the image former 300 based on the program stored in the memory. The controller 200 may be composed of one or more control circuits.

The image former 300 forms, on the recording material 1, an image corresponding to image data. The image data may be image data that is read by the image reader 100, or may be image data that is transmitted from a communication terminal such as a personal computer or a smartphone. The recording material 1 is, for example, generally a sheet of printing paper. An image is formed, for example, by printing in which toner contained in a developer is adhered to a sheet of paper. In actual printing, when a user operates the operation display 400, first, a sheet of paper as the recording material 1 is delivered from the paper feed tray 500 to the image former 300. Next, the image former 300 forms an image on the recording material 1. Then, the recording material 1 on which the image is formed is discharged onto the paper discharge tray 20.

### Process Performed by Controller 200

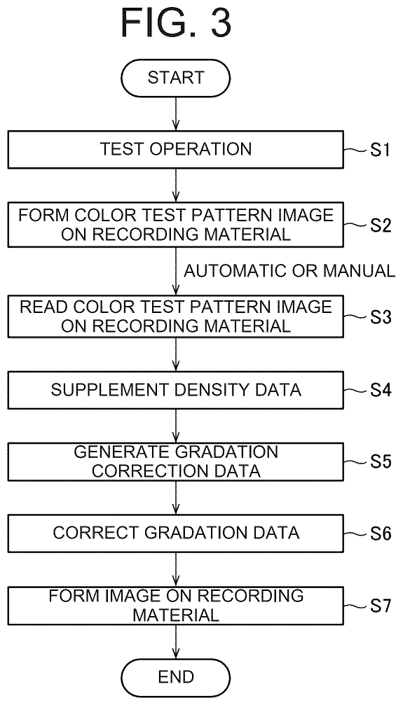

FIG. 3 is a flowchart illustrating a process performed by the controller 200 of the image forming apparatus 1000 according to the present embodiment.

As illustrated in FIG. 3, in step S1, a user operates the operation display 400 to form a test pattern image on the recording material 1. Thus, in step S2, the controller 200 causes the image former 300 to form a test pattern image on the recording material 1 and discharge, onto the paper discharge tray 20, the recording material 1 on which the test pattern image is formed.

Next, in step S3, the user places, on the manual feed tray 10, the recording material 1 on which the test pattern image is formed, and operates the operation display 400 to read the test pattern image. Thus, in step S3, the image reader 100 reads the test pattern image formed on the recording material 1.

However, when the image reader 100 is a scanner dedicated to a test pattern image that is used only to form a test pattern image on the recording material 1, a process different from the process in steps S2 and S3 is performed. In that case, in step S2, the image former 300 forms a test pattern image on the recording material 1, and before the recording material 1 is discharged onto the paper discharge tray 20, in step S3, the image reader 100 automatically reads the test pattern image on the recording material 1.

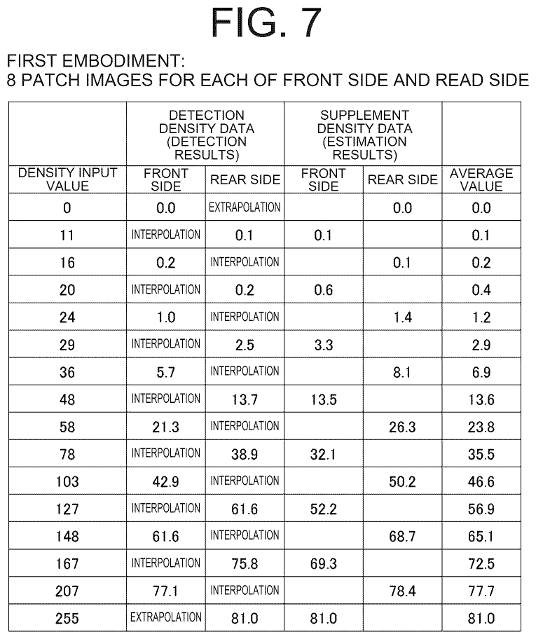

A test pattern image (see FIG. 5) of the present embodiment includes a first patch image group (front side) and a second patch image group (rear side). The first patch image group includes, for each color, a plurality of first patch images (only one row in a sub scanning direction in FIG. 5) that correspond to certain parts (e.g., 0, 16, 24, 36, 58, 103, 148, 207 in FIG. 7) of a group of density input values (e.g., 0 to 255 in FIG. 7). The second patch image group includes, for each color, a plurality of second patch images (only one row in the sub scanning direction in FIG. 5) that correspond to other parts (e.g., 11, 20, 29, 48, 78, 127, 167, 255 in FIG. 7) of the group of density input values (e.g., 0 to 255 in FIG. 7). Details of the test pattern image will be described below with reference to FIG. 5.

In a case where the test pattern image on the recording material 1 is read by the image reader 100, the controller 200 acquires a plurality of pieces of first detection density data respectively corresponding to the plurality of first patch images and a plurality of pieces of second detection density data respectively corresponding to the plurality of second patch images.

Next, in step S4, the controller 200 supplements detection density data included in image data obtained by reading the test pattern image. Specifically, the controller 200 generates first supplement density data (front side) from the group of density input values (0 to 255 in FIG. 7) and the plurality of pieces of first detection density data (front side in FIG. 7) by at least one of interpolation and extrapolation of the plurality of pieces of first detection density data. Furthermore, the controller 200 generates second supplement density data (see the rear side in FIG. 7) from the group of density input values (0 to 255 in FIG. 7) and the plurality of pieces of second detection density data (see the rear side) by at least one of interpolation and extrapolation of the plurality of pieces of second detection density data. Details of this will be described below with reference to FIG. 7.

Next, in step S5, the controller 200 acquires the plurality of pieces of first detection density data, the second detection density data, the first supplement density data, and the second supplement density data. Thus, the controller 200 causes the recording medium 120 to store gradation correction data in a data table format.

Then, in step S6, in a case where a command signal for image formation is received from the operation display 400, the controller 200 corrects a group of gradation data included in the image data using the gradation correction data stored in the recording medium 120.

Next, in step S7, the controller 200 controls the image former 300 to form, on the recording material 1, an image corresponding to the image data including the group of gradation data subjected to gradation correction by calibration. Thus, the image subjected to gradation correction is formed on the recording material 1. Then, the image former 300 discharges, onto the paper discharge tray 20, the recording material 1 on which the image subjected to gradation correction is formed.

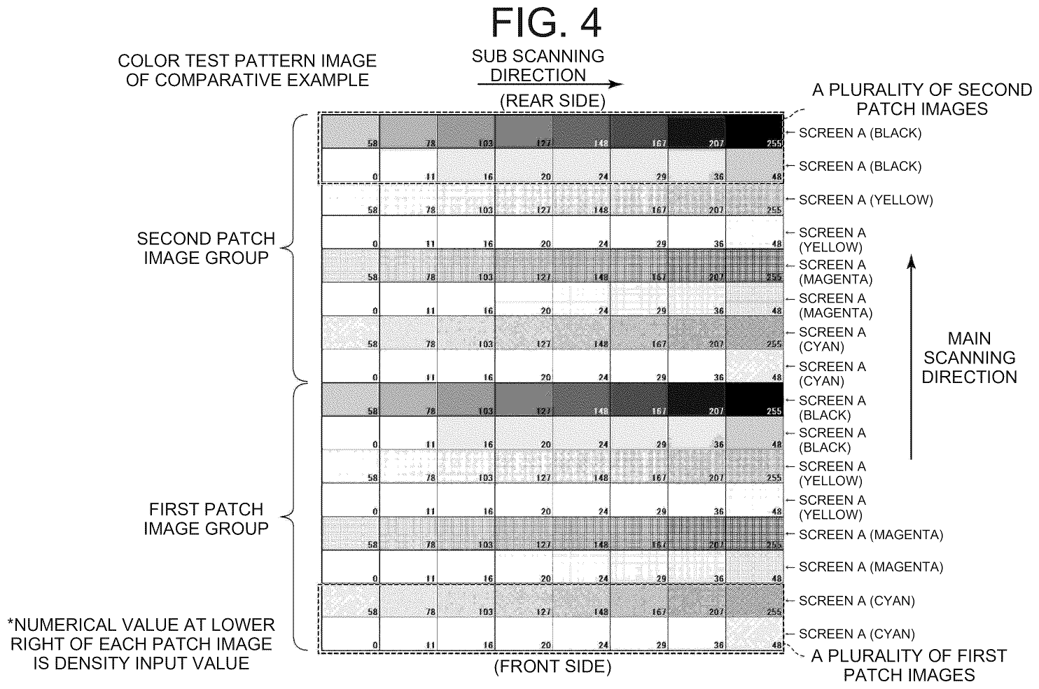

FIG. 4 is a diagram illustrating a test pattern image of an image forming apparatus 1000 according to a comparative example. FIG. 5 is a diagram illustrating a test pattern image of the image forming apparatus 1000 according to the present embodiment. The test pattern images may be a full-color image or a monochrome image.

In the present specification, the front side means the front surface side of the image forming apparatus 1000, and means the right side of the recording material 1 in the direction in which the recording material 1 is conveyed during image formation by the image former 300. Furthermore, the rear side means the back surface side of the image forming apparatus 1000, and means the left side of the recording material 1 in the direction in which the recording material 1 is conveyed during image formation by the image former 300. In the present specification, a main scanning direction of the image former 300 is a direction perpendicular to the direction in which the recording material 1 is conveyed, and a sub scanning direction of the image former 300 is a direction parallel to the direction in which the recording material 1 is conveyed. These apply to the following embodiments. In the present embodiment, a plurality of patch images are arranged in a row in the sub scanning direction; however, the plurality of patch images may be arranged in a row in the main scanning direction.

As can be seen from the comparison of FIGS. 4 and 5, the test pattern images of both the comparative example and the present embodiment include a first patch image group and a second patch image group. In the test pattern images of both the comparative example and the present embodiment, a plurality of first patch images (one row in the sub scanning direction) are arranged in the sub scanning direction of the image former 300. Furthermore, in the test pattern images of both the comparative example and the present embodiment, a plurality of second patch images (one row in the sub scanning direction) are arranged in the sub scanning direction of the image former 300. Furthermore, in the test pattern images of both the comparative example and the present embodiment, the first patch image group and the second patch image group are arranged in the main scanning direction of the image former 300. However, as can be seen from the comparison of FIGS. 4 and 5, the test pattern image of the comparative example and the test pattern image of the present embodiment differ from each other in the following points.

The first patch image group (front side) of the comparative example illustrated in FIG. 4 includes 16 first patch images (two rows in the sub scanning direction) for each of black, yellow, magenta, and cyan. On the other hand, the first patch image group (front side) of the present embodiment illustrated in FIG. 5 includes 8 first patch images (only one row in the sub scanning direction) for each of black, yellow, magenta, and cyan. Furthermore, the second patch image group (rear side) of the comparative example illustrated in FIG. 4 includes 16 second patch images (two rows in the sub scanning direction) for each of black, yellow, magenta, and cyan. On the other hand, the second patch image group (rear side) of the present embodiment illustrated in FIG. 5 includes 8 second patch images (only one row in the sub scanning direction) for each of black, yellow, magenta, and cyan.

Thus, the test pattern image of the present embodiment illustrated in FIG. 5 can have a smaller area than the test pattern image of the comparative example illustrated in FIG. 4. In other words, in a case where the patch images have the same size, the test pattern image of the present embodiment illustrated in FIG. 5 allows a larger number of patch images to be formed on a recording material 1 having the same area than the test pattern image of the comparative example illustrated in FIG. 4. Thus, in the present embodiment, for example, a test pattern image can be formed on the recording material 1 using an A4-sized recording material 1 instead of an A3-sized recording material 1.

As illustrated in FIG. 5, the test pattern image of the present embodiment includes only one row of first patch images for each color, and only one row of second patch images for each color. This makes it easy to design arrangement of the plurality of first patch images and the plurality of second patch images. In the present embodiment, in each row of the plurality of first patch images and the plurality of second patch images, the patch images are arranged in order of density input value; however, the plurality of first patch images and the plurality of second patch images may be randomly arranged.

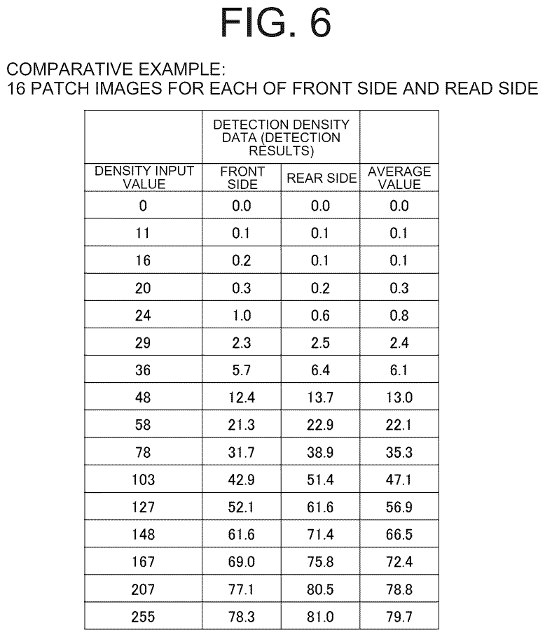

FIG. 6 is a diagram illustrating a relationship between a density input value and an average value of two detection density data (detection results) on the front side and the rear side of the image forming apparatus according to the comparative example. In FIG. 6, the average value is an average of a value of detection density data (detection results) on the front side and a value of the corresponding detection density data (detection results) on the rear side, and is rounded off to the first decimal place.

As illustrated in FIG. 6, the image forming apparatus according to the comparative example acquires density detection data on the front side and the rear side corresponding to all values of the group of density input values (0 to 255) without performing interpolation or extrapolation of the density detection data. Thus, patch images of the same number as the number corresponding to the group of density input values (0 to 255) need to be formed on each of the front side and the rear side of the recording material 1.

FIG. 7 is a diagram illustrating a relationship between a density input value, two detection density data (detection results) and two supplement density data (estimation results) on the front side and the rear side, and an average value of the two detection density data and the two supplement density data of the image forming apparatus 1000 according to the present embodiment. In the present specification, the term “supplement” means estimation of density data from a plurality of detection density data actually detected, by at least one of “interpolation” and “extrapolation”.

In FIG. 7, the detection density data in a field denoted as “interpolation” is calculated as a simple average of the detection density data in the field above the “interpolation” field and the detection density data in the field below the “interpolation” field. Furthermore, in FIG. 7, a numerical value obtained as a simple average for an “interpolation” field is shown in the corresponding field for the supplement density data (estimation results) in the same row as the “interpolation” field. However, in FIG. 7, the detection density data in an “interpolation” field may be calculated as a weighted average of the detection density data in the field above the “interpolation” field and the detection density data in the field below the “interpolation” field. Interpolation may be any method of obtaining a numerical value estimated in the range based on known numerical data.

In FIG. 7, for the detection density data in a field denoted as “extrapolation”, a numerical value equal to the value of detection density data in the field on the right or left side of the “extrapolation” field is shown in the corresponding field for the supplement density data (estimation results) in the same row as the “extrapolation” field. Extrapolation may be any method of obtaining a numerical value estimated outside the range based on known numerical data.

In FIG. 7, the average value includes a simple average value of a value of detection density data (detection results) on the front side and a value of supplement density data (estimation results) on the rear side in the same row as the value of detection density data. Furthermore, the average value includes a simple average value of a value of detection density data (detection results) on the rear side and a value of supplement density data (estimation results) on the front side in the same row as the value of detection density data.

As can be seen from the comparison of FIGS. 6 and 7, unlike the comparative example, in the present embodiment, a value of detection density data corresponding to a patch image removed from the test pattern image of the comparative example is estimated by interpolation or extrapolation of the detection density data actually obtained.

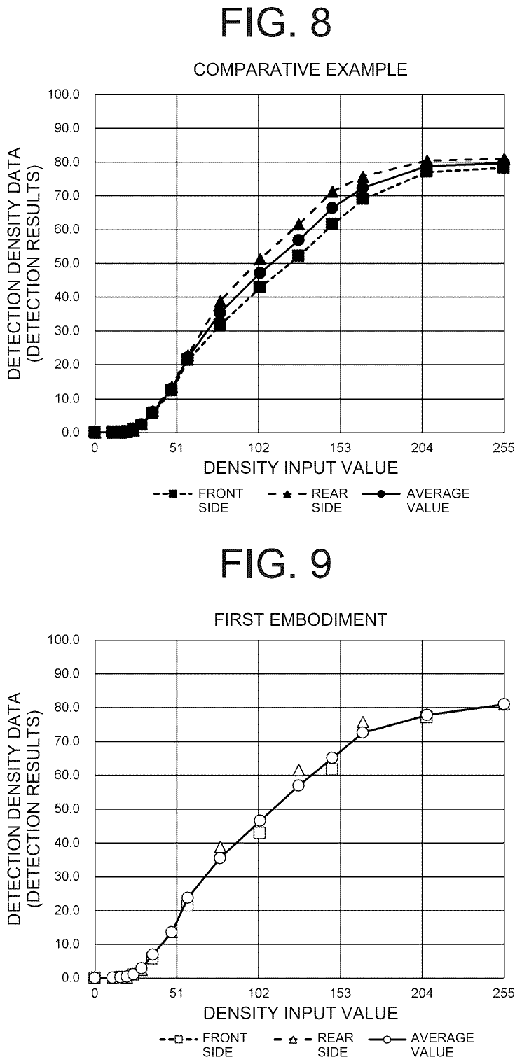

FIG. 8 is a graph illustrating a relationship between a density input value and an average value of two detection density data on the front side and the rear side of the image forming apparatus according to the comparative example. FIG. 9 is a graph illustrating a relationship between a density input value and an average value of two detection density data on the front side and the rear side of the image forming apparatus 1000 according to the present embodiment.

As can be seen from the comparison of FIGS. 8 and 9, the graph for the test pattern image of the present embodiment is close to the graph for the test pattern image of the comparative example in a line connecting the plurality of average values. Thus, the test pattern image of the present embodiment allows calibration with substantially the same level of accuracy using a smaller number of density detection data items than the test pattern image of the comparative example. In other words, the present embodiment achieves a test pattern image including a smaller number of patch images without reducing the accuracy of calibration.

### Second Embodiment

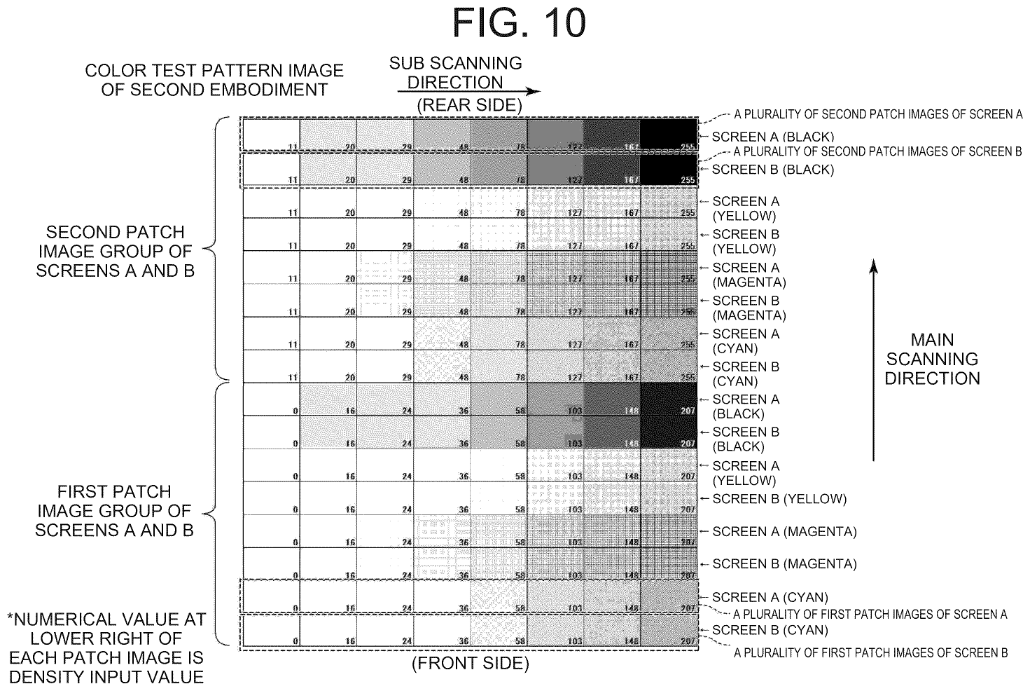

An image forming apparatus and an image forming method according to a second embodiment will be described with reference to FIG. 10. In the following, the same points as in the image forming apparatus and the image forming method according to the first embodiment will not be repeatedly described. The image forming apparatus and the image forming method according to the present embodiment differ from the image forming apparatus and the image forming method according to the first embodiment in the following points.

FIG. 10 is a diagram illustrating a test pattern image of the image forming apparatus 1000 according to the present embodiment.

As illustrated in FIG. 10, a test pattern image of the present embodiment includes a plurality of types of screens A and B different from each other. The plurality of types of screens A and B are assumed to be, for example, a screen for copying, a screen for printing, or the like. In the present specification, the term screen means a screen obtained by converting a continuous tone by a halftone process, for example, using dots, parallel lines, or error diffusion pattern with discrete density. In the same type of screen, a plurality of patch images are formed in a mode with different densities using the same halftone process.

The test pattern image of the present embodiment includes a first patch image group and a second patch image group for each of the plurality of types of screens A and B. Also in the present embodiment, the first patch image group and the second patch image group are arranged in the main scanning direction of the image former 300.

However, in the present embodiment, in the first patch image group, a plurality of first patch images of a screen A that are arranged in the sub scanning direction (one row in the sub scanning direction) and a plurality of first patch images of a screen B that are arranged in the sub scanning direction (one row in the sub scanning direction) are alternately and repeatedly arranged. Furthermore, in the second patch image group, a plurality of second patch images of a screen A that are arranged in the sub scanning direction (one row in the sub scanning direction) and a plurality of second patch images of a screen B that are arranged in the sub scanning direction (one row in the sub scanning direction) are alternately and repeatedly arranged.

The present embodiment enables a test pattern image including the plurality of types of screens A and B to be formed on a single recording material 1. Thus, it is possible to simultaneously perform calibration of both (all) the plurality of types of screens A and B without substantially reducing the accuracy of calibration or substantially changing the amount of recording material 1 and toner used.

### Third Embodiment

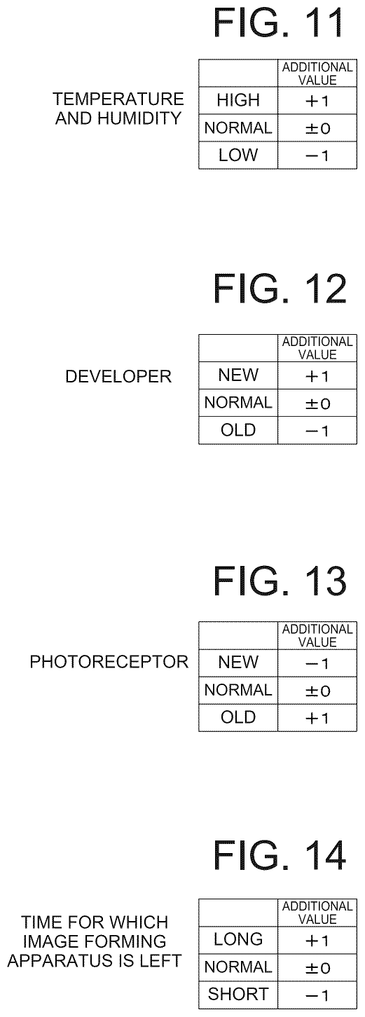

An image forming apparatus and an image forming method according to a third embodiment will be described with reference to FIGS. 11 to 17. In the following, the same points as in the image forming apparatus and the image forming method according to the first or second embodiment will not be repeatedly described. The image forming apparatus and the image forming method according to the present embodiment differ from the image forming apparatus and the image forming method according to the first or second embodiment in the following points.

Device information acquired by the image forming apparatus 1000 will be described with reference to FIGS. 11 to 14.

FIG. 11 is a diagram illustrating a relationship between the magnitude of temperature and humidity and an additional value of the image forming apparatus 1000 according to the present embodiment.

As illustrated in FIG. 11, the device information includes information on the magnitude of temperature and humidity around the image forming apparatus 1000. In the present embodiment, in a case where the magnitude of temperature and humidity of the atmosphere around the image forming apparatus 1000 is more than a threshold a, the additional value is set to +1. In a case where the magnitude of temperature and humidity of the atmosphere around the image forming apparatus 1000 is less than a threshold b that is lower than the threshold a, the additional value is set to −1. Furthermore, in a case where the magnitude of temperature and humidity of the atmosphere around the image forming apparatus 1000 is between the threshold a and the threshold b (normal), the additional value is set to +0.

The temperature and humidity are respectively measured by a thermometer and a hygrometer incorporated in the image forming apparatus 1000. In the present embodiment, a single additional value is determined for the temperature and humidity; however, a single additional value may be determined for each of the temperature and humidity.

FIG. 12 is a diagram illustrating a relationship between the freshness of a developer and an additional value of the image forming apparatus 1000 according to the present embodiment. Information on the developer is also use history information on a component of the image forming apparatus 1000.

As illustrated in FIG. 12, the device information includes information on the developer of the image forming apparatus 1000. In the present embodiment, in a case where the elapsed time from the start of use of the developer in the image forming apparatus 1000 is less than a threshold a (new), the additional value is set to +1. In a case where the elapsed time from the start of use of the developer in the image forming apparatus 1000 is more than a threshold b that is higher than the threshold a (old), the additional value is set to −1. Furthermore, in a case where the elapsed time from the start of use of the developer in the image forming apparatus 1000 is between the threshold a and the threshold b (normal), the additional value is set to +0.

FIG. 13 is a diagram illustrating a relationship between the freshness of a photoreceptor and an additional value of the image forming apparatus 1000 according to the present embodiment.

As illustrated in FIG. 13, the device information includes information on the photoreceptor as a photosensitive drum that forms an image of the image forming apparatus 1000. Information on the photoreceptor is also use history information on a component of the image forming apparatus 1000.

In the present embodiment, in a case where the elapsed time from the start of use of the photoreceptor in the image forming apparatus 1000 is less than a threshold a (new), the additional value is set to −1. In a case where the elapsed time from the start of use of the photoreceptor in the image forming apparatus 1000 is more than a threshold b that is higher than the threshold a (old), the additional value is set to +1. Furthermore, in a case where the elapsed time from the start of use of the photoreceptor in the image forming apparatus 1000 is between the threshold a and the threshold b (normal), the additional value is set to +0.

FIG. 14 is a diagram illustrating a relationship between the length of time for which the image forming apparatus 1000 is left and an additional value of the image forming apparatus 1000 according to the present embodiment. Information on the time for which the image forming apparatus 1000 is left is also use situation information on the image forming apparatus 1000.

As illustrated in FIG. 14, the device information includes information on the time for which the image forming apparatus 1000 is not used. In the present embodiment, in a case where the time for which the image forming apparatus 1000 is left and not used is more than a threshold b that is higher than a threshold a, the additional value is set to +1. In a case where the time for which the image forming apparatus 1000 is left and not used is less than the threshold b, the additional value is set to −1. Furthermore, in a case where the time for which the image forming apparatus 1000 is left and not used is between the threshold a and the threshold b (normal), the additional value is set to +0.

Other than the device information illustrated in FIGS. 11 to 14, simple gradation detection information may be used as device information.

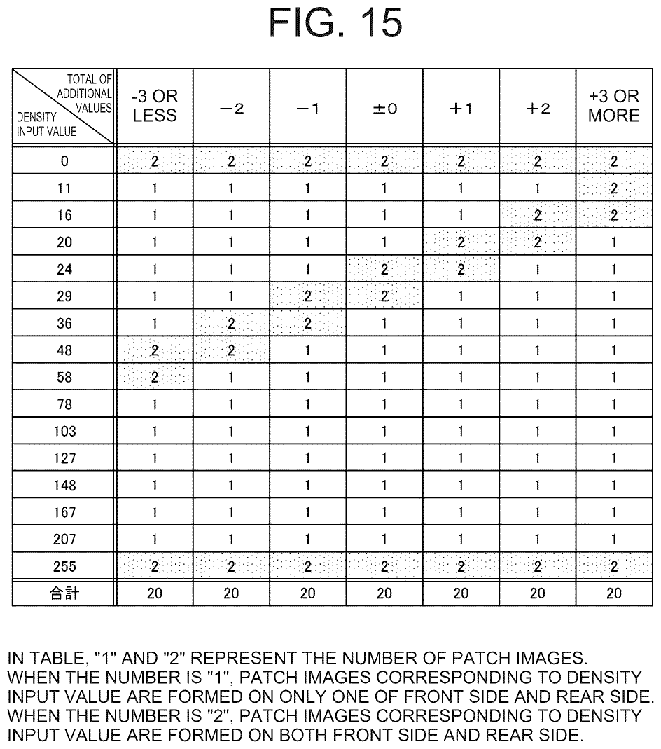

FIG. 15 is a diagram illustrating an example of the number of patch images that is determined based on a density input value and additional values of the image forming apparatus 1000 according to the present embodiment.

The total of the additional values for the device information described above is calculated. The number of patch images corresponding to each density input value is determined based on the total of the additional values. For example, as illustrated in FIG. 15, when the total of the additional values is −3, −2, −1, +0, +1, +2, or +3, a value in the corresponding column shown in FIG. 15 is used. Thus, the number of patch images corresponding to each of the group of density input values (0 to 255 in FIG. 15) is determined to be 1 or 2.

When the number of patch images is 1, patch images corresponding to the density input value are formed on only one of the front side and the rear side. When the number of patch images is 2, patch images corresponding to the density input value are formed on both the front side and the rear side.

For example, when the total of the additional values is −3 and the density input value is 0, 48, 58, or 255, the number of patch images is 2, and thus patch images are formed on both the front side and the rear side. When the total of the additional values is −3 and the density input value is other than 0, 48, 58, or 255, the number of patch images is 1, and thus patch images are formed on only one of the front side and the rear side.

Other than the method in which the state is quantified based on the device information as described above, a method in which test pattern image data is formed inside the image forming apparatus 1000 before a test pattern image is formed on the recording material 1 may be used. In that case, the image forming apparatus 1000 may directly recognize the number of patch images based on the results of simple gradation detection in which test pattern image data is detected by a sensor inside the image forming apparatus 1000.

Specifically, for example, patch image data including all the density input values shown in FIG. 15 is formed inside the image forming apparatus 1000. Thus, as the result detected by simple gradation detection, the number of patch image data items in which there is a large difference between the density input value of a single patch image data item and each of two density input values close to the density input value is set to 2. At this time, no image is transferred onto the recording material 1. In this case, a plurality of patch image data items are discarded inside the image forming apparatus 1000. Thus, even if all the patch image data items are formed, it is possible to achieve a lower cost than when a plurality of patch images are actually transferred onto the recording material 1.

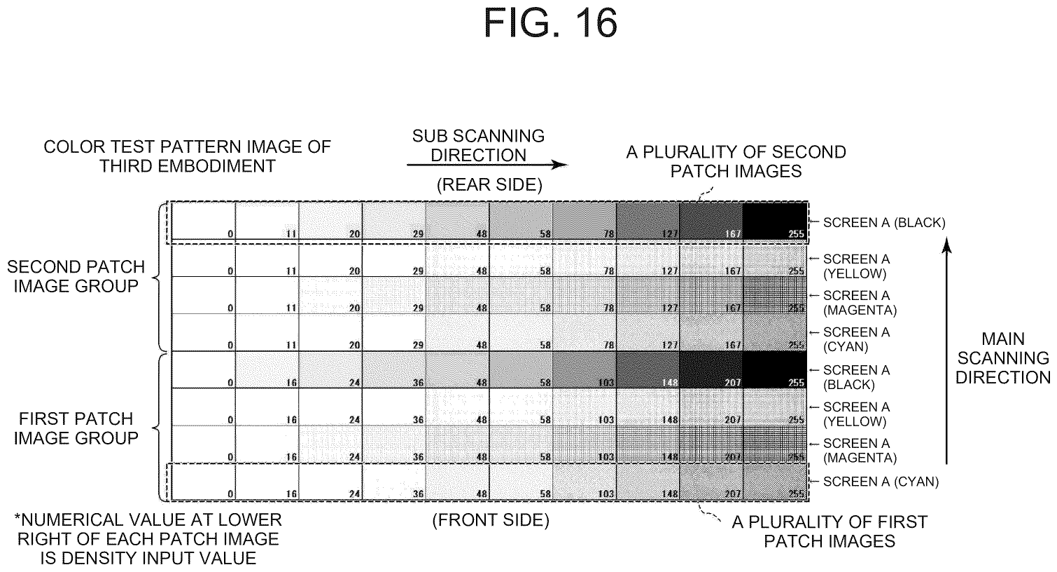

FIG. 16 is a diagram illustrating a test pattern image of the image forming apparatus 1000 according to the present embodiment.

As illustrated in FIG. 16, when the density input value is 0, 48, 58, or 255, patch images are formed on both the front side and the rear side. When the density input value is other than 0, 48, 58, or 255, patch images are formed on only one of the front side and the rear side.

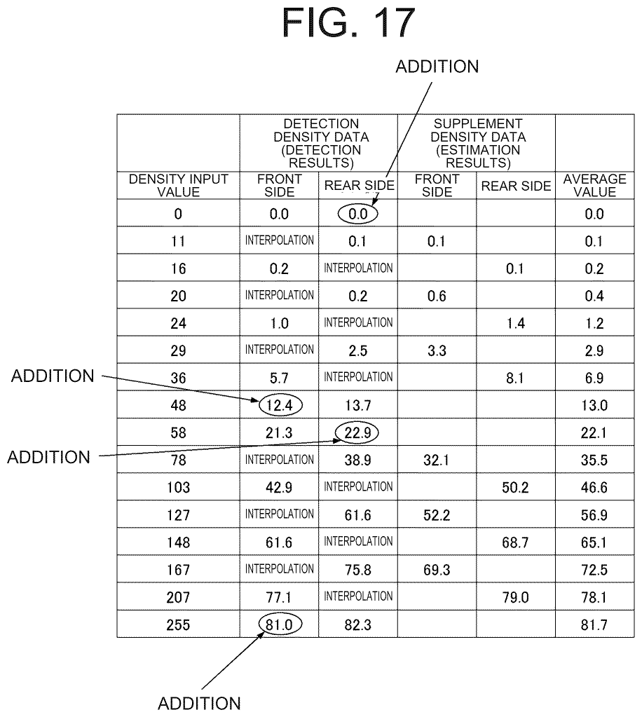

FIG. 17 is a diagram illustrating a relationship between a density input value, detection density data (detection results) and supplement density data (estimation results) on the front side and the rear side, and an average value of the detection density data and the supplement density data of the image forming apparatus 1000 according to the present embodiment. In FIG. 17, numerical values in the fields with the term “addition” are not values estimated by interpolation or extrapolation but values of actual detection density data of patch images.

As illustrated in FIG. 17, detection density input values in the fields with the term “addition” are not values calculated by interpolation or extrapolation but values of detection density data of patch images actually measured. The detection density input values in the fields with the term “addition” are acquired using a larger number of patch images of the test pattern image as illustrated in FIG. 16 than the number of patch images illustrated in FIG. 15. However, the detection density data actually measured is used instead of the estimation results obtained by interpolation or extrapolation, and thus it is possible to achieve calibration with higher accuracy. By limiting the detection density data in the fields with the term “addition” to detection density data with a high degree of importance, it is possible to effectively achieve calibration with higher accuracy while causing the total number of patch images to be small to some extent.

That is, an important patch image of the test pattern image of the present embodiment is formed on the recording material 1 to actually acquire detection density data without using supplement density data (estimation results). Thus, although the test pattern image of the present embodiment includes a slightly larger number of patch images than the test pattern image of the first embodiment, it is possible to achieve a test pattern image including a smaller number of patch images without significantly reducing the accuracy of calibration.

As is clear from the above description, the controller 200 of the present embodiment acquires at least one piece of device information of information on the temperature of the ambient environment and the humidity of the surrounding environment, use history information, and use situation information of the image forming apparatus 1000. The controller 200 determines an additional value (−3, −2, −1, +0, +1, +2, or +3) based on the acquired device information. The controller 200 determines a plurality of density input values (0 to 255) based on the additional value or simple gradation detection information. The controller 200 causes the image former 300 to form a test pattern image on the recording material 1 based on the determined density input values of the plurality of first patch images and the determined density input values of the plurality of second patch images.

That is, the controller 200 determines, based on the device information, the plurality of density input values of the plurality of first patch images and the plurality of density input values of the plurality of second patch images.

While there have been described what are at present considered to be certain embodiments of the disclosure, it will be understood that various modifications may be made thereto, and it is intended that the appended claim cover all such modifications as fall within the true spirit and scope of the disclosure.

What is claimed is:

1. An image forming apparatus comprising:
an image reader that reads a test pattern image;
an image former that forms an image on a recording material; and
a controller that controls the image reader and the image former, wherein the controller
causes the test pattern image to be formed on the recording material, the test pattern image including a plurality of first patch images that correspond to certain parts of a plurality of density input values and a plurality of second patch images that correspond to other parts of the plurality of density input values,
acquires a plurality of pieces of first detection density data that correspond to the plurality of first patch images and a plurality of pieces of second detection density data that correspond to the plurality of second patch images, in a case where the test pattern image is read by the image reader,
generates first supplement density data from the certain parts of the plurality of density input values and the plurality of pieces of first detection density data by at least one of interpolation and extrapolation of the plurality of pieces of first detection density data,
generates second supplement density data from the other parts of the plurality of density input values and the plurality of pieces of second detection density data by at least one of interpolation and extrapolation of the plurality of pieces of second detection density data,
generates gradation correction data using the plurality of pieces of first detection density data, the plurality of pieces of second detection density data, the first supplement density data, and the second supplement density data, and
the image former forms the image on the recording material based on the gradation correction data.

2. The image forming apparatus according to claim 1, wherein
the test pattern image includes a plurality of types of screens different from each other, and includes the plurality of first patch images and the plurality of second patch images for each of the plurality of types of screens.

3. The image forming apparatus according to claim 2, wherein
the plurality of types of screens include a first type screen and a second type screen,
the plurality of first patch images of the first type screen and the plurality of first patch images of the second type screen are alternately and repeatedly arranged, and
the plurality of second patch images of the first type screen and the plurality of second patch images of the second type screen are alternately and repeatedly arranged.

4. The image forming apparatus according to claim 1, wherein
the controller
acquires at least one piece of device information of information on a temperature of an ambient environment and a humidity of a surrounding environment, use history information, and use situation information of the image forming apparatus,
determines an additional value based on the device information, and
determines the plurality of density input values based on the additional value.

5. The image forming apparatus according to claim 3, wherein
the controller
acquires at least one piece of device information of information on a temperature of an ambient environment and a humidity of a surrounding environment, use history information, and use situation information of the image forming apparatus, and
determines the plurality of density input values based on the device information.

6. An image forming method executed by one or more processors, the image forming method comprising:
forming, on a recording material, a test pattern image including a plurality of first patch images that correspond to certain parts of a plurality of density input values and a plurality of second patch images that correspond to other parts of the plurality of density input values,
acquiring a plurality of pieces of first detection density data that correspond to the plurality of first patch images and a plurality of pieces of second detection density data that correspond to the plurality of second patch images, in a case where the test pattern image is read from the recording material,
generating first supplement density data from the certain parts of the plurality of density input values and the plurality of pieces of first detection density data by at least one of interpolation and extrapolation of the plurality of pieces of first detection density data,
generating second supplement density data from the other parts of the plurality of density input values and the plurality of pieces of second detection density data by at least one of interpolation and extrapolation of the plurality of pieces of second detection density data,
generating gradation correction data using the plurality of pieces of first detection density data, the plurality of pieces of second detection density data, the first supplement density data, and the second supplement density data, and
forming the image on the recording material based on the gradation correction data.
